(19) United States
(12) Patent Application Publication
(10) Pub. No.: US 2025/0139361 A1
(43) Pub. Date: May 1, 2025

(54) METHOD AND SYSTEM FOR EVALUATING AND SCORING EMOTIONAL IMPACT OF A PIECE OF WRITING BASED ON LEMMA ANALYSIS AND READER FEEDBACK

(71) Applicant: Laura Randant, San Juan, PR (US)

(72) Inventor: Laura Randant, San Juan, PR (US)

(21) Appl. No.: 18/923,795

(22) Filed: Oct. 23, 2024

Related U.S. Application Data
(60) Provisional application No. 63/545,598, filed on Oct. 25, 2023.

(51) Int. Cl. G06F 40/253; G06F 40/237; G06F 40/30

(52) U.S. Cl. CPC G06F 40/253; G06F 40/237; G06F 40/30

(57) ABSTRACT

A method is provided for evaluating a piece of writing by creating a database of lemmas and assigning each lemma an emotional impact score that is used to categorize words as power words or non-power words. Each lemma is assigned a contextual rarity score. A facility score is provided based on the number of concepts per sentence, the complexity of the lemmas, and the comprehension score of the lemmas in a passage. An intensity map and a facility map are created for the piece of writing, and an overall score is provided based on percentage of power words, the ratio of positive to negative words, the intensity map, and the facility map. Machine learning and Reader feedback may be incorporated into the emotional impact score and a resonance score may be assigned based on the percentage of the target market captured by the piece of writing.

### CROSS-REFERENCE TO RELATED APPLICATIONS

This application claims benefit from currently pending U.S. Provisional Application No. 63/545,598 titled “Method and System for Evaluating and Scoring Emotional Impact Of A Piece Of Writing Based On Lemma Analysis And Reader Feedback” and having a filing date of Oct. 25, 2023, all of which is incorporated by reference herein.

### FIELD OF THE INVENTION

The present invention relates generally to the field of text analysis, and more specifically to a method for automatically evaluating a piece of writing based on a variety of factors.

### DESCRIPTION OF RELATED ART

Among the many indignities facing potential authors is the amount of time it takes publishers to review and evaluate a manuscript that has been submitted for publishing. Publishers, especially well-known publishers, receive a substantial number of manuscript submissions regularly. Manuscript review requires careful evaluation, editing, and consideration for publication and limited staff and available resources make timely manuscript review a perpetual challenge. Publishers aim to maintain high standards for the quality of the content they publish, and a thorough review process is seen as necessary to ensure that the published works meet these standards. Moreover, publishers, and readers generally, can have distinct preferences for writing styles and content.

Existing methods in the field of literary recommendation are forced to rely on human reviewers who base their suggestions on their unique knowledge and inherently subjective preferences. The effectiveness of human reviewers depends on their familiarity with a broad range of texts and even expert human reviewers often struggle to evaluate and appreciate a book's stylistic nuances.

As a supplement to subjective human review, tools like the Flesch-Kincaid Readability Test and Lexile Scoring offer readability assessments but do not make predictive recommendations or consider higher-level stylistic elements. Automated system has not been able to fully evaluate potentially complex works to identify compelling reading subject matter, and solutions for the manuscript backlog rely on automating workflow processes to move a manuscript from one human reviewer to another or to shepherd the human reviewer through a series of tasks to complete a review. Human reviewers remain a bottleneck, introducing delays and subjectivity into the publishing decision-making process. An automated review of manuscript submissions is needed to relieve the bottleneck.

Moreover, the evaluation of written content often involves the analysis of various linguistic elements such as lemmas, nouns, adjectives, and the overall sentence structure. This requires a deep understanding of the language and a high level of linguistic competency. However, not all evaluators may possess the necessary linguistic skills and knowledge, which can further complicate the evaluation process. In addition, the evaluation of written content often involves the assessment of the emotional impact of the words used. This can be a complex and subjective process, as the emotional impact of a word can vary depending on the context in which it is used. Furthermore, the emotional impact of a word can also vary among different readers, adding another layer of complexity to the evaluation process.

Therefore, there is a need for a method that can objectively and efficiently evaluate a piece of writing, taking into account various factors such as the complexity of the language, the emotional impact of the words used, the comprehension level required, and the overall structure and organization of the content. Such a method would be beneficial in various fields, including education, publishing, and content creation, and could significantly streamline the process of evaluating written content.

So as to reduce the complexity and length of the Detailed Specification, and to fully establish the state of the art in certain areas of technology, Applicant(s) herein expressly incorporate(s) by reference all of the following materials identified in each numbered paragraph below. The incorporated materials are not necessarily “prior art” and Applicant(s) expressly reserve(s) the right to swear behind any of the incorporated materials.

U.S. Pub. No. 20140278375A1 to Ahmad et al. Methods and system for calculating affect scores in one or more documents.

U.S. Pat. No. 7,610,313B2 US to Kawai et al. System and method for performing efficient document scoring and clustering.

U.S. Pub. No. 20200051453A1 to Sung et al. Scoring method and system for divergent thinking test.

U.S. Pat. No. 6,418,435B1 to Chase et al. System for quantifying intensity of connotative meaning.

U.S. Pat. No. 9,542,381B2 to Anisimovich. Automatic training of a syntactic and semantic parser using a genetic algorithm.

U.S. Pat. No. 10,585,985B1 to Flor et al. Systems and methods for automatic detection of idiomatic expressions in written responses

U.S. Pub. No. 20060206806A1 to Han et al. Text summarization.

U.S. Pub. No. 20220366333A1 to Lollo et al. Machine learning and natural language processing for assessment systems.

U.S. Pub. No. 20120276505A1 to Al Badrashiny et al. System and method for rating a written document.

U.S. Pub. No. 20140278357A1 to Horton, Russell. Word generation and scoring using sub-word segments and characteristic of interest.

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), applicant(s) will amend the specification to expressly recite the essential material that is incorporated by reference as allowed by the applicable rules.

### SUMMARY OF THE INVENTION

The present invention provides among other things a method including creating a database of lemmas, or root forms of words, and assigning each lemma an emotional impact score. This score is comprised of a comprehension score, an intensity score, a complexity tag, and a polarity tag. Words are categorized as power words or non-power words based on the emotional impact score, and each lemma in the piece of writing is assigned a rarity score that is customized for the piece of writing. The method also includes creating an intensity map of the intensity of the reading experience over the piece of writing and creating a facility map of the facility or ease of reading over the piece of writing. The piece of writing is then scored to provide an overall score based on the percentage of words that are power words, the ratio of positive to negative words, the intensity map and the facility map.

The emotional impact score is evaluated based on at least one of a polarity tag and an intensity tag. The intensity tag is a number ranging from 1 to 10. The comprehension tag comprises the percentage of English speakers who know each lemma, by age. The complexity tag describes the mental exertion required to process each lemma. The polarity tag is positive, negative, or neutral and may include an amplifier tag. The rarity score comprises a contextual rarity score and is dynamic, based on a word vector, and is increased based on uncommon word combinations.

The method further includes weighting the first and last words of each sentence of the language and amplifying words within a sentence that are capitalized. The facility score comprises a point system that assigns the passage as a desired number of words, categorizes each word and each sentence as difficult or not difficult, issues one or more point for each passage, deducts a point for each difficult word and each difficult sentence, sequentially scores the piece of writing and assigns a reader fatigue flag whenever the score becomes negative, tallies the reader fatigue flags, and assigns the facility score based on the number and magnitude of the reader fatigue flags.

The piece of writing further comprises a plurality of paragraphs and a plurality of chapters, and the overall score is calculated by sentence, by paragraph, and summarized by chapter. The plurality of chapters can be automatically assigned as a predetermined portion of the piece of writing. An element of the facility score is density. The overall score can be summarized into at least two core scores comprising an impact score made up of the comprehension score and the density of the language, and a consistency score made up of the variance of the comprehension score and the density over the piece of writing.

The method further can comprise receiving reader feedback on the piece of writing by providing a user interface to at least one reader, receiving feedback on sections of text in the piece of writing from the user and incorporating the reader feedback into the emotional impact score. The piece of writing has a target market and a resonance score is assigned based on the percentage of the target market captured by the piece of writing.

It is an object of the invention to provide an automatic evaluation of a written text.

It is another object of the invention to reduce or eliminate the backlog for manuscript evaluation at publishing houses.

It is another object of the invention to efficiently identify good writing.

It is another object of the invention to provide a machine learning feedback loop

for assessing written works.

It is another object of the invention to clarify why a piece of writing works or doesn't work.

It is another object of the invention to provide automated instantaneous feedback for a submitted manuscript.

It is another object of the invention to reduce the number of manuscripts that must be reviewed by a human reviewer at publishing houses.

It is another object of the invention to provide a tool that gives preliminary feedback to prospective authors before submission of a manuscript.

It is another object of the invention to evaluate marketability of written works by tracking statistics which might be relevant to reader experience, such as language acquisition tolerance levels or reader fatigue, and then comparing them to reader behavior and market success.

It is another object of the invention to evaluate what percentage of market success of a written work can be attributed to manuscript quality.

It is another object of the invention to provide a score that can be compared against other possible factors of success such as author productivity, release schedules, promotion efforts, and distribution support.

It is another object of the invention to reduce risk at publishing houses by identifying which factors of language and reader experience impact market success most heavily at the current moment, and then reporting those factors per manuscript for data-driven decisions in the selection, nurturing, and promotion of each work and author.

It is another object of the invention to reduce bias and increase story diversity by providing improved evaluation tools for high ingenuity, high potential works.

It is another object of the invention to identify manuscripts with few comparable analogs that could be used to estimate market success, or manuscripts which might not align with the individual tastes of editors but resonate with untapped or underrepresented markets.

It is another object of the invention to improve diversity and access in the publishing industry, by identifying manuscripts and writers with high potential despite small networks, disability, uncertainty, or poor visibility of the publishing process.

It is another object of the invention to speed up the publishing process generally and help providers of literature become more responsive to audience demand in a timely manner.

It is an object of the invention to quantify experiential aspects of language for the purpose of statistical analysis.

It is another object of the invention to further scientific understanding around the emotional experience of language beyond logical definitions or grammatical mechanics.

It is another object of the invention to provide an objective score to educate and assist writers, to offer meaningful feedback early in the creative process, and help them more efficiently produce creative works that are market-viable.

It is another object of the invention to design a writing quality standard for minimum viable creative writing that is extremely efficient and provably beneficial to readers.

It is another object of the invention to understand and track the emotional impact portion of linguistic drift, over time.

It is another object of the invention to evaluate language fluidity, reader acceptance of new words, the coinage and adoption of new words, and changes in emotional impact/charge of words over time, including tracking fallout when words suddenly fall into disuse.

It is another object of the invention to map emotional impact and linguistic drift by

location and demographic.

It is another object of the invention to understand ideal audiences for a written piece.

It is another object of the invention to identify the potential for divergent experiences with a single written work (where different readers have vastly different experiences with the same piece).

It is another object of the invention to provide a framework to understand how a work might be edited to broaden appeal.

It is another object of this invention to build a dynamic, up-to-date map of language that is adequately tagged and labeled to be compared for research in the disciplines of linguistics, sociology, politics, marketing, business, translation, literature, and art.

It is an object of this invention to provide a framework for mapping a language or dialect.

It is another object of the invention to improve automated translation that takes emotional and experiential nuances of language into account. The above and other objects may be achieved using methods involving evaluating a piece of writing. The method involves creating a database of lemmas, each assigned an emotional impact score that includes a fluff word signifier, a comprehension score, an intensity score, a complexity tag, and a polarity tag.

The fluff word signifier identifies whether a word is a fluff word. The comprehension score comprises the percentage of English speakers who know each lemma by age and reflects how well the word is expected to be comprehended by the target audience. The intensity tag is a number ranging from 1 to 10 and reflects the sense of intensity or urgency invoked by the lemma. The complexity tag describes the mental exertion required to process each lemma, once the lemma is comprehended. The polarity tag is positive, negative, or neutral and may include an amplifier tag. Words may be categorized as power words or non-power words based on the emotional impact score. Power words would be words that are considered to be concrete, familiar, and relatively intense.

Each lemma in the piece of writing is also assigned a rarity score that is customized for the piece of writing, scoring the frequency of individuals lemmas by genre or other specific context. The rarity score may be dynamic, adjusting when significant changes in word usage occur over time through linguistic drift. In a particular embodiment, lemmas are stored as word vectors—numerical representations of a word in a high-dimensional vector space.

The rarity score may be multiplied by the comprehension score to give an idea of how each lemma will affect reader comprehension and flow.

The total ease of reading is evaluated in a facility score. The nouns and distinct adjectives found in the piece of writing may be assigned into concepts and the ease of reading may be scored based on the number of concepts per sentence, the complexity of the lemmas, and the comprehension score of the lemmas in a passage. Density may also be an element of the facility score.

Reading ease may be expressed as a percentage of readers in a target audience who can breeze through a passage with reasonable cognitive effort. In a particular embodiment, the facility score comprises a point system that sets a desired number of words as a passage and issues one or two points for each passage.

The method may include creating a facility map and an intensity map of the piece of writing. The facility map is a scheme of the ease of reading the piece of writing over the course of the piece. The intensity map tracks the cadence of the piece of writing, or the balance of intensity statistics over the full manuscript.

The piece of writing is scored to provide an overall score based on the percentage of words that are power words, the ratio of positive to negative words, the intensity map, and the facility map. The overall score may be calculated by sentence, by paragraph, and summarized by chapter.

The overall score may be summarized into at least two core scores comprising an impact score made up of the comprehension score and the density of the language. The impact score may more particularly be expressed as the density divided by the comprehension score. Consistency is the second core score. Consistency is made up of the variance of the comprehension score and the range of density over the piece of writing. Manuscripts with the highest impact score are recommended the most highly. After ranking manuscripts by impact, the manuscripts may be sorted by consistency.

Reader feedback on the piece of writing is received by providing a user interface to at least one reader, receiving feedback on sections of text in the piece of writing from the user, and incorporating the reader feedback into the emotional impact score. The piece of writing has a target market, and a resonance score is assigned based on the percentage of the target market captured by the piece of writing.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for, and will also recite the word “function” (i.e., will state “means for performing the function of . . . ”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF DRAWINGS

A more complete understanding of the present invention may be derived by referring to the detailed description when considered in connection with the following illustrative figures. In the figures, like reference numbers refer to like elements or acts throughout the figures.

FIG. 1A depicts a flowchart illustrating a method for evaluating a piece of writing, according to some embodiments of the present disclosure.

FIG. 1B depicts a flowchart extending from FIG. 1A and further illustrating the method for evaluating a piece of writing, according to some embodiments of the present disclosure.

FIG. 2 depicts a flowchart further illustrating the method for evaluating a piece of writing from FIG. 1A, according to some embodiments of the present disclosure.

Elements and acts in the figures are illustrated for simplicity and have not necessarily been rendered according to any particular sequence or embodiment

### DETAILED DESCRIPTION OF THE INVENTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. It should be noted that there are many different and alternative configurations, devices, and technologies to which the disclosed inventions may be applied. The full scope of the inventions is not limited to the examples that are described below.

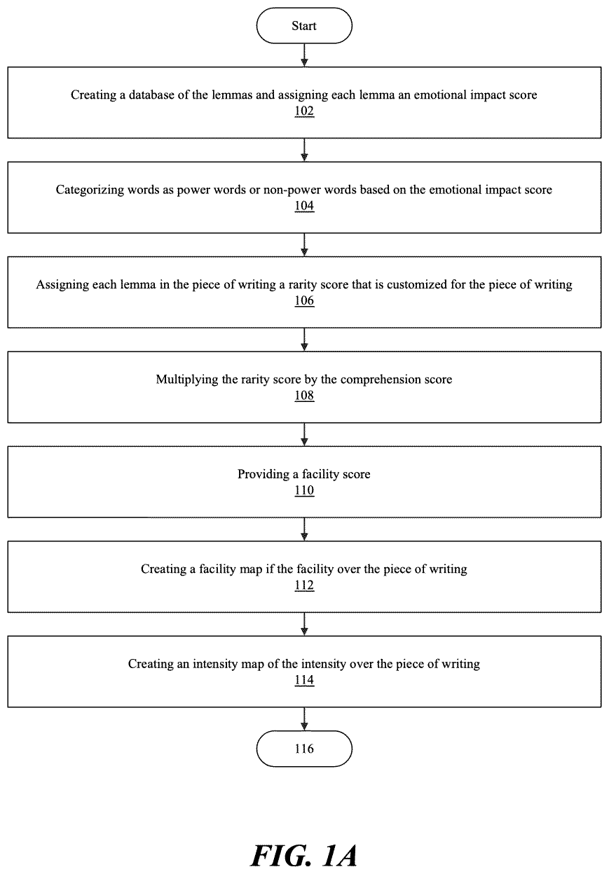

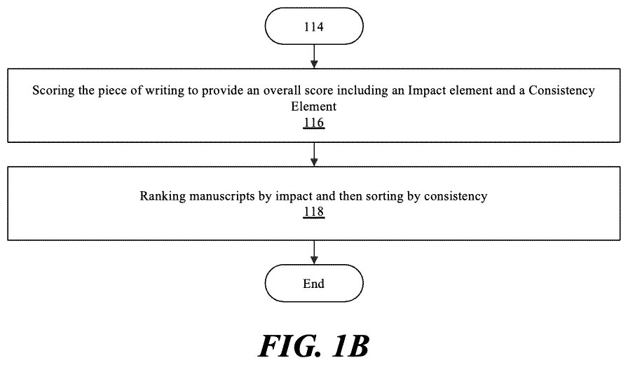

In one application of the invention, FIGS. 1A to 1B are flowcharts that describe a method for evaluating a piece of writing, according to some embodiments of the present disclosure. In some embodiments, at 102, the method may include creating a database of the lemmas and assigning each lemma an emotional impact score. The database of lemmas is maintained to acknowledge and validate new lemmas that are introduced when evaluating a new piece of writing. When a piece of writing includes a new lemma, the lemma is added to the database and assigned an emotional impact score. The impact score may be added automatically with default values, or a program may be run to determine default values based on usage of the lemma in other contexts. The new lemma may be flagged and the location of use of the lemma in the piece of writing highlighted to allow staff to evaluate the lemma in its context in the piece of writing and input an emotional impact score.

The emotional impact score includes a fluff word signifier, a comprehension score, an intensity score, a complexity tag, and a polarity tag. The fluff word signifier identifies whether a word is a fluff word. Fluff words are emotionally empty words whose sole purpose is to prop up other words. Fluff words cannot be eliminated, but they should be minimized. Fluff words include:
passive/helping/auxiliary verbs—am, is, are, was, were, be, being, been, do, does, did, have, has, had, ought, can, could, may, might, must, should, shall will, would, ought, and [contractions];
articles and pronouns—the, a, an, she/her, he/his, they/them/their, we/our, you, I/me/mine, thee, it, neo-pronouns, who, what, which, other, some, everybody, one, none, anybody, no one, this/that/these/those, all, another, any, anything, anyone, as, aught, both, each, either, enough, few, many, most, nothing, one, other, several, what, whence, which, such, neither/either;
Coordinating conjunctions & subordinate words—for, and, nor, but, or, yet, so, after, as though, if when, now that, supposing, whenever, sho, as, before, inasmuch, once, that, whereas, as long as, even if, just as, provided that, though, wherever, as soon as, if, now, since, until, which;
prepositional phrases—at, of, by, to, in, on, but, for;
paired adjectives—using multiple words to describe something instead of one word that is precise.

The comprehension score comprises the percentage of English speakers who know each lemma by age and reflects how well the word is expected to be comprehended by the target audience. Learning curves allow one comprehension outlier per 750 words or so, to accommodate audience language acquisition. After this, words outside the comprehension tolerance of the target audience start to hurt the sentence scores.

The intensity tag is a number ranging from 1 to 10 and reflects the sense of intensity or urgency invoked by the lemma. The intensity of the word may be given an amplifier based on how the word is used in the text. The complexity tag describes the mental exertion required to process each lemma once the lemma is comprehended. In a particular embodiment, the complexity tag identifies the lemma as belonging to one of four tiers, with tier 4 being the most complex and tier 1 being the least complex. All word power scores are divided by their complexity score if they have a high complexity tier (3, 4) to identify reading ease. Fog Index is also used to identify dense passages. The polarity tag indicates whether a given lemma is positive, negative, or neutral. Negatively-charged words are naturally louder than positively charged words. To achieve a neutral tone, positive words need to outweigh negative words. When the rarity of the word is evaluated, the presence of other positively or negatively charged words may be relevant.

Words may be categorized as power words or non-power words based on the emotional impact score. Power words would be words that are considered to be concrete, familiar, and relatively intense.

The table below summarizes principles that may be used to determine the emotional impact that word has.

| | | Weak/Strong |
|---|---|---|
| Attribute | Effect (Weight Bonus) | Examples |
| Emotional | The raw idea's intensity + | Asked/Begged |
| Charge | positive/negative charge. The | |
| (Vibe) | first and easiest way to boost | |
| | a word's emotional score. | |
| Simplicity | Simple words are stronger. | Candelabra/Candle |
| | Readers hate straining to | |
| | understand. | |
| | Simplification is the first | |
| | step in clear communication. | |
| | Exception: | |
| | A complex word may have | |
| | increased impact if the overall | |
| | piece has low mental strain | |
| | and the complex word doesn't | |
| | interrupt | |
| | comprehension. | |
| Concrete-ness | Humans prefer things they can | Clues/Crumbs |
| | touch. | Affectionate/Warm |
| | Good writing replaces abstract | |
| | ideas with concrete, tangible | |
| | metaphors. | |
| | Emotions are usually | |
| | somewhat tactile, felt in | |
| | specific places in the body. | |
| Familiarity | Two words for the same | Buggy/Shopping Cart |
| | thing-“buggy” and “shopping | |
| | cart”-are equally | |
| | concrete, equally simple, | |
| | and even equally common | |
| | according to global use. | |
| | But a reader's personal | |
| | familiarity with one or the | |
| | other gives it a massive boost. | |
| Precision | Precise words like hawk | She/Sarah |
| | convey more information | Bird/Hawk |
| | than bird, despite both | |
| | being accurate, simple, | |
| | concrete, and familiar. | |
| | As a bonus, Precision usually | |
| | increases rarity. However, | |
| | precision is less important | |
| | than reading ease. | |
| Resonance | The degree to which a raw | bumblebee, pistachio, |
| | sound is pleasing or | swindle, collude, bizarre, |
| | displeasing to the ear. | sweeten, defrock, |
| | Sentences tightly strung with | zigzag, effervescent, |
| | meaningful words tend to | insidious, flippant, |
| | have strong resonance. | hypnosis, languish, |
| | | kaleidoscope |

At 104, the method may include categorizing words as power words or non-power words based on the emotional impact score. Power words would be words that are especially concrete, familiar, and intense. At 106, the method may include assigning each lemma in the piece of writing a rarity score that may be customized for the piece of writing. Words don't have to be complicated to be rare, and readers calculate rarity according to context. While a hammer is common in a workshop, a hammer is rare inside a nursery. It is rare for a voice to hammer—more expected in a large man, but a surprise coming from someone shy. The following words all appear less than 20 times per million words generally, and in fiction average around one mention per thousand books: charm, sunny, hammer, keyboard, persist, wheat, predator, bizarre, ducklings, feral. Most words can be twisted into an unlikely part-of-speech. Charm works as an adjective but carries weight as a verb. Ducklings is a great seed for a simile. Feral can describe an animal, or a sorority, or a city planner's street layout. Using familiar words in an uncommon way substantially reduces the predictability of prose, which readers appreciate.

The rarity score may be dynamic, adjusting when significant changes in word usage occur over time through linguistic drift. In a particular embodiment, lemmas are stored as number sets known as word vectors. A word vector is a numerical representation of a word in a high-dimensional vector space. These representations are used in natural language processing (NLP) and machine learning tasks to capture the semantic meaning of words and their relationships with other words in a way that can be processed by computers. Word vectors have become a fundamental component in many NLP applications, including text classification, machine translation, sentiment analysis, and more. Word vectors may be used for more precise co-occurrence rarity scores to evaluate how unusual a word choice is based on its precise location relative to other lemmas.

In word vectors, each word is represented as a vector of real numbers, typically with hundreds or even thousands of dimensions. Each dimension in the vector represents a specific feature or aspect of the word's meaning. Words that have similar meanings or are used in similar contexts tend to have similar word vectors. This property allows word vectors to capture semantic relationships between words. For example, in a well-trained word embedding model, the vectors for “king” and “queen” might be close to each other in the vector space because they are both related to royalty. Word vectors exhibit interesting mathematical properties. For example, you can perform vector arithmetic operations on word vectors to find analogies.

The classic example is the equation “king−man+woman=queen,” where you can use word vectors to find a word that is analogous to “queen” in the same way that “king” is analogous to “man” and “woman” is analogous to “queen.” Word vectors can be pretrained on large text corpora to capture general language semantics. Popular pretrained word embedding models include Word2Vec, GloVe, and FastText. These pretrained models can be used as a starting point for NLP tasks or fine-tuned on specific datasets. In addition to static word vectors, there are models that provide contextualized embeddings, such as BERT (Bidirectional Encoder Representations from Transformers). These embeddings take into account the surrounding words in a sentence, allowing them to capture word meanings in context. Word vectors may be used for more precise co-occurrence rarity scores to evaluate how unusual a word choice is based on its precise location relative to other lemmas.

In some embodiments, at 108, the method may include multiplying the rarity score by the comprehension score to give weight to words that are rare because of context over words that are rare because they are rarely used. Multiplying rarity by comprehension also gives a better indication of the impact wording may have. Rare word usage is inherently impactful on a reader, but only when it is understood.

Nouns and distinct adjectives may be assigned as concepts to account for reader fatigue. Humans can only hold about six ideas at a time—like a string of six numbers—before we must start lumping them together or repeating them under our breath to move them to short-term memory. These concepts may be referred to as “attention points”. Every human has six attention points to spend, and some may be spent based on the general anxiety being experienced by the reader at any given time. For example, social anxiety can perpetually occupy one or two attention points. Multitasking parents who work from home always spend one attention point listening for toddler emergencies in the background. Attention point limitations are also the reason we sometimes space out while people are talking to us. The range of concepts per sentence should average 2-4. Any sentence with 0 may be characterized as fluff. Sentences with 5-6 concepts may be characterized as difficult. Any sentence with 6+ concepts may be characterized as unreadable.

At 110, the method may include providing a facility score based on the number of concepts per sentence, the complexity of the lemmas, and the comprehension score of the lemmas in a passage. Density may also be an element of the facility score. Density is the ratio of high value words to low value words in each sentence, paragraph, passage, or other selection of text. The first and last words of each sentence and words within a sentence that are capitalized may be weighted in the density. For example, the first and last words of each sentence are amplified at 2.5× each word's natural weight. In this example, when the first or last word is a high value word, that word will count as 2.5 high value words when determining the ratio of high value words to low value words to determine sentence density Words that are capitalized inside a sentence are lightly amplified at 1.2× the word's score. High value words woven tightly give readers the impression of confidence. Reading ease may be expressed as a percentage of readers in a target audience who can breeze through passage with reasonable cognitive effort.

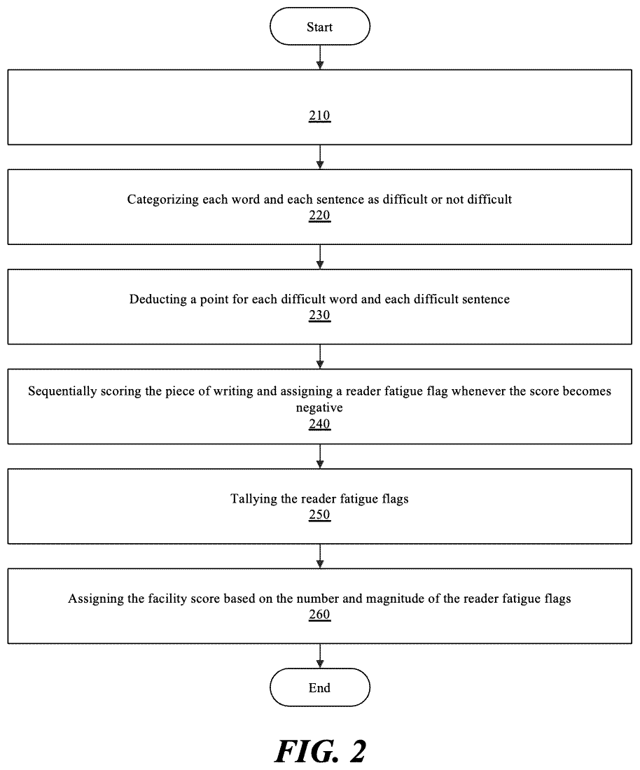

At 112, the method may include creating a facility map if the facility over the piece of writing. The fatigue flags described with reference to FIG. 2 may constitute the facility map. At 114, the method may include creating an intensity map of the intensity over the piece of writing. The intensity map tracks the cadence of the piece of writing, or the balance of intensity statistics over the full manuscript. Smooth growth of intensity over time is preferred and the intensity map may indicate a divergence from the expected level of intensity at each portion of the manuscript for the target genre and audience.

At 116, the method may include scoring the piece of writing to provide an overall score based on the percentage of words that may be power words, the ratio of positive to negative words, the intensity map and the facility map. The overall score may be calculated by sentence, by paragraph, and summarized by chapter. In some embodiments, the plurality of chapters may be automatically assigned as a predetermined portion of the piece of writing. At 118, the method may include ranking manuscripts by impact and then sorting by consistency.

In some embodiments, the method may include summarizing the overall score into at least two core scores. An impact score made up of the comprehension score and the density of the language, and a consistency score made up of the variance of the comprehension score and the density over the piece of writing. In some embodiments, the method may include receiving reader feedback on the piece of writing by providing a user interface to at least one reader, receiving feedback on sections of text in the piece of writing from the user and incorporating the reader feedback into the emotional impact score. The piece of writing may have a target market and further comprising assigning a resonance score based on the percentage of the target market captured by the piece of writing.

The lemma database may be continually updated using feedback to adjust the initial values used to determine emotional impact scores in the lemma database. Reader feedback, sales data, publication offers, contract payment size or other tangible responses to a piece of writing may be used to update the values in the lemma database to reflect known outcomes more accurately. All infrastructure feedback refines the initial emotional impact scores in the lemma database through many continuous rounds of data collection, updating and refinement until the model converges.

FIG. 2 is a flowchart that further describes the method for evaluating a piece of writing from FIG. 1A, according to some embodiments of the present disclosure. In some embodiments, the facility score comprises a point system that sets a desired number of words as a passage and issues one or two points for each passage. As an example, every 500 words the reader may be assumed to gain 2 “concentration points.” Each word and each sentence can be categorized as difficult or not difficult, and points may be deducted for each difficult word and each difficult sentence. Complex words that are understood by some but not all readers cost a concentration point. And highly intense negative words cost a concentration point. An aggregate score is tallied at each position in the piece of writing. When the score becomes negative, a reader fatigue flag may be assigned. The reader fatigue flags may be tallied, and a facility score assigned based on the number and magnitude of the reader fatigue flags. The method can include facility score comprising a point system that has assigning the passage as a desired number of words, at 210. At 220, categorizing each word and each sentence as difficult or not difficult. Issues one or more point for each passage. Deducting a point for each difficult word and each difficult sentence, at 230. Sequentially scoring the piece of writing and assigning a reader fatigue flag whenever the score becomes negative, at 240. Tallying the reader fatigue flags, at 250 and assigning the facility score based on the number and magnitude of the reader fatigue flags at 260.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. The terms “including” and “such as” are not limiting and should be interpreted as “including, but not limited to,” and “such as, for example,” respectively. Moreover, any combination of the above-described embodiments in all possible variations thereof is encompassed by the disclosure unless otherwise indicated herein or otherwise clearly contradicted by context.

I claim:

1. A method for evaluating a piece of writing having a plurality of words organized into a plurality of sentences, wherein each word has a lemma and wherein at least some sentences comprise at least one noun and at least one distinct adjective, the method comprising:
creating a database of the lemmas and assigning each lemma an emotional impact score that comprises:
a fluff word signifier;
a comprehension score,
an intensity score;
a complexity tag in which lemmas are categorized based on complexity and assigned a complexity signifier, and
a polarity tag in which each lemma is categorized as positive, negative, or neutral;
categorizing words as power words or non-power words based on the emotional impact score;
assigning each lemma in the piece of writing a rarity score that is customized for the piece of writing,
assigning the nouns and the distinct adjectives into concepts;
providing a facility score based on the number of concepts per sentence, the complexity of the lemmas, and the comprehension score of the lemmas in a passage;
creating an intensity map of the intensity over the piece of writing;
creating a facility map of the facility over the piece of writing;
scoring the piece of writing to provide an overall score based on the percentage of words that are power words, the ratio of positive to negative words, the intensity map and the facility map.

2. The method of claim 1 wherein the emotional impact score is evaluated based on at least one of a polarity tag; an intensity tag.

3. The method of claim 2 wherein the intensity tag is a number ranging from 1 to 10.

4. The method of claim 2 wherein the comprehension tag comprises the percentage of English speakers who know each lemma, by age.

5. The method of claim 2 wherein the complexity tag describes the mental exertion required to process each lemma.

6. The method of claim 2 wherein the polarity tag is positive, negative, or neutral.

7. The method of claim 6 wherein the polarity tag includes an amplifier tag.

8. The method of claim 1 wherein the rarity score comprises a contextual rarity score.

9. The method of claim 1 wherein the rarity score is dynamic.

10. The method of claim 1 wherein the rarity score is based on a word vector.

11. The method of claim 1 wherein the rarity score is increased based on uncommon word combinations.

12. The method of claim 1 further comprising weighting the first and last words of each sentence of the language.

13. The method of claim 12 wherein the weight given to the first and last words of each sentence is a multiplier of 2.5.

14. The method of claim 1 wherein words within a sentence that are capitalized are amplified.

15. The method of claim 14 wherein the weight given to words within a sentence that are capitalized is a multiplier of 1.2.

16. The method of claim 1 wherein the facility score comprises
a point system comprising:
assigning the passage as a desired number of words;
categorizing each word and each sentence as difficult or not difficult, issues one or more point for each passage;
deducting a point for each difficult word and each difficult sentence;
sequentially scoring the piece of writing and assigning a reader fatigue flag whenever the score becomes negative;
tallying the reader fatigue flags; and
assigning the facility score based on the number and magnitude of the reader fatigue flags.

17. The method of claim 1 wherein the piece of writing further comprises a plurality of paragraphs and a plurality of chapters, and wherein the overall score is calculated by sentence, by paragraph, and summarized by chapter.

18. The method of claim 17 wherein the plurality of chapters are automatically assigned as a predetermined portion of the piece of writing.

19. The method of claim 1 wherein an element of the facility score is density.

20. The method of claim 1, further comprising summarizing the overall score into at least two core scores comprising:
an impact score made up of the comprehension score and the density of the language;
a consistency score made up of the variance of the comprehension score and the density over the piece of writing.

21. The method of claim 1 further comprising receiving reader feedback on the piece of writing by providing a user interface to at least one reader, receiving feedback on sections of text in the piece of writing from the user and incorporating the reader feedback into the emotional impact score.

22. The method of claim 1, wherein the piece of writing has a target market and further comprising assigning a resonance score based on the percentage of the target market captured by the piece of writing.
